(19) United States
(12) Patent Application Publication
(10) Pub. No.: US 2018/0290147 A1
(43) Pub. Date: Oct. 11, 2018

(54) DEVICE FOR THE COMMINUTION OF MATERIALS

(71) Applicant: DIEFFENBACHER GMBH MASCHINEN- UND ANLAGENBAU, Eppingen (DE)

(72) Inventors: Helmut BAUSER, Eppingen (DE); Jochen KAMM, Eppingen (DE); Ulrich VOSS, Eppingen (DE)

(73) Assignee: DIEFFENBACHER GMBH MASCHINEN- UND ANLAGENBAU, Eppingen (DE)

(21) Appl. No.: 15/762,910

(22) PCT Filed: Sep. 23, 2016
(86) PCT No.: PCT/EP2016/072716

§ 371 Date: Mar. 23, 2018

(30) Foreign Application Priority Data
Sep. 25, 2015 (DE) 10 2015 116 285.7

(51) Int. Cl. B02C 13/282; B02C 13/14

(52) U.S. Cl. CPC B02C 13/282; B02C 2210/02; B02C 13/14

(57) ABSTRACT

A device for the comminution of moisture-containing materials includes a housing that forms an impact chamber having a rotating striking means driven therein via a shaft. The housing includes a bottom plate, a cover, a wall connecting the bottom plate and the cover, an inlet opening and an outlet opening. A tub including at least one layer of plastic is arranged at least along the bottom plate. A wear plate is arranged on an other side of the layer of plastic. Objects of the invention include increasing the wear resistance of the device, realizing self-cleaning effects and enabling simple and safe cleaning, in particular, at a standstill.

The invention relates to a device for the comminution of materials according to the preamble of claim 1.

For the comminution of components of mixtures of substances, or of articles composed of various materials, such as metal parts, glass, rubber, wood, polymers, fibrous materials, composites or the like, in particular for the purpose of economic recycling, it has been known in the prior art to use impact reactors, in which the components are crushed by an impact stress by means of impact elements. Thus, for example, document EP 0 859 693 B1 discloses a vertical mill which has a cylindrical main body as a housing for an impact chamber and a rotatable rotor therein, wherein the rotor is adjustable in height in the main body and comprises exchangeable impact elements as an impact body, which elements are releasably received at its wing-shaped ends. From EP 1 721 674 B1 a vertical mill is known in which it is proposed to attach at least one discharge flap to the cylindrical side or to the bottom of the vertical mill. Preferably, an external screen is to be replaced by a discharge flap in this case. The drive is arranged outside of the impact chamber.

The definition as a vertical mill results from the vertically rotatably driven shaft for the striking means.

The above devices and methods have fundamentally proven their worth, wherein the starting materials to be comminuted usually have no or only a slight moisture, usually occurring as surface moisture due to storage under the open sky.

For the comminution of expired foods or materials which have a higher basic or own moisture content and partly free water, the above devices are only partially suitable. In particular, in a mixed comminution of various materials in packaging, the previously separated contents can contribute together and/or with the packaging itself to the formation of health-endangering, galvanic or even explosive mixtures.

For such an extreme application, the above methods and devices are only partially or not at all suitable.

It is the object of the present invention to provide a device with which material flows, preferably with high moisture content and/or metallic content, can be comminuted, wherein the wear resistance and any optional safety requirements can be met.

The invention is based on a device for the comminution of preferably moisture-containing materials, comprising a housing to form an impact chamber having a rotating striking means driven therein by means of a preferably vertically oriented shaft, wherein a bottom plate, a cover, a wall connecting the bottom plate and cover, and an inlet and an outlet opening are arranged as the housing of the impact chamber.

The materials may contain mixed plastics and metals with biogenic components. These may consist, for example, of expired foods which are to be separated from their packaging and, for example, supplied for recycling to a biogas plant.

The solution to the problem for the device is that in the impact chamber a tub consisting of at least one layer of plastic is arranged at least along the bottom plate and, on the other side of the layer of plastic, a wear plate is arranged.

The invention thus provides the following advantages:
Simple steel construction of the body
Protection of steel structure from tribological effects, especially against acid and corrosion
Simplified cleaning
Self-cleaning effect
Secure avoidance of the formation of a galvanic element between main body, wear layer and/or the input material streams.

In a further preferred embodiment of the invention, the tub and/or the wear plate can be designed in several parts. The junction points are preferably materially bonded and sealed. Thus, especially in the case of a material stream with a metallic content or liquids which could trigger a galvanic reaction, it is ensured that the housing is separated from the impact chamber. It is preferably provided that the tub encloses the entire impact chamber. Depending on the application, it may be sufficient to use the bottom plate and proportionately the wall toward the lid for the formation of the tub.

In a multi-part tub and a multi-part wear plate, the junction points of the tub segments and the wear plates can be arranged substantially spaced from each other. This increases the sealing effect and minimizes wear on the junction points, seams or welds.

It may preferably be provided that, in the region of the outlet opening on the bottom plate, the tub and/or the wear plate are made integrally and arranged as an orifice plate. This orifice plate may preferably almost include the opening angle of the outlet opening and is thus is easy to replace in a simple way.

Preferably, a harder material than the material of the housing can be arranged for the wear plate, for example Hardox 400 or Hardox 600. Hardox is the manufacturer's designation of a wear plate.

Alternatively or in combination, in the region of the outlet opening, the wear plate and/or the tub may be arranged with a gradient to the outside. This allows a liquid to emerge from the impact chamber without difficulty.

Alternatively or in combination, at least partially the tub, the wear plate and/or the orifice plate may be arranged in the region of the bottom plate with a gradient in the direction of the outlet opening. Again, a self-cleaning effect is to be made possible in that the existing fluids, especially at standstill of the device, can automatically escape from the device. In conjunction with manual or automated flushing, it is thus possible to prevent residual material in the device from causing odors, gases or other chemical reactions when the device is not in operation.

Alternatively or in combination, the tub and/or the wear plate may be arranged in the region of the bottom plate from the wall with a gradient in the direction of the shaft. This embodiment also serves the self-cleaning effect and also prevents deposits at the transition between the bottom plate and the wall.

Alternatively or in combination, at least one depression in the wear plate and/or in the plastic material can be arranged on the impact chamber side in the region of the bottom plate to form a channel, wherein the channel is preferably in operative connection with the outlet opening by a gradient. By implementing a channel, the features described above can be enhanced or the self-cleaning effect can be introduced.

Alternatively or in combination, the shaft may be arranged inclined relative to the bottom plate and/or the axis substantially perpendicular to the orientation of the gradient in the direction of the outlet opening.

It can obviously also be provided that the invention finds application in a comparable impact device with a horizontally arranged shaft. Of course, the invention can also be used in cutting devices according to the teaching and protect the impact chamber or the outer shell in a useful way.

Alternatively or in combination, compensating pieces can be arranged between the wear plate of the wall and the wear plate of the bottom plate, preferably made of the same material. This is particularly advantageous if a gradient is arranged in the region of the bottom plate. In this case, the wear plates can still be made uniformly and only the easily manageable or producible compensating pieces require a special geometry.

Alternatively or in combination, an elevation, preferably in the form of a cone, may be arranged in the region of the passage of the shaft through the bottom plate, the tub and/or the wear plate in the direction of the impact chamber. The elevation causes a seal against a liquid in the impact chamber or supports in its effect an existing seal between the shaft and the bottom plate.

In this context, it is preferably provided that the surface of the elevation or of the cone in the region of the striking means is arranged plane-parallel to the plane of the rotational movement of the striking means. This prevents pinching of the materials between the rotary impact tool and the bottom plate.

Alternatively or in combination, it may be provided that the junction points between the wear plates are used as a channel.

Alternatively or in combination, overlaps or tongue-and-groove connections may be arranged at the junction points between the wear plates to prevent the ingress of moisture or other substances between the wear plates, respectively between the wear plates.

Details and embodiments of the invention are explained in closer detail by reference to the enclosed drawings, wherein:

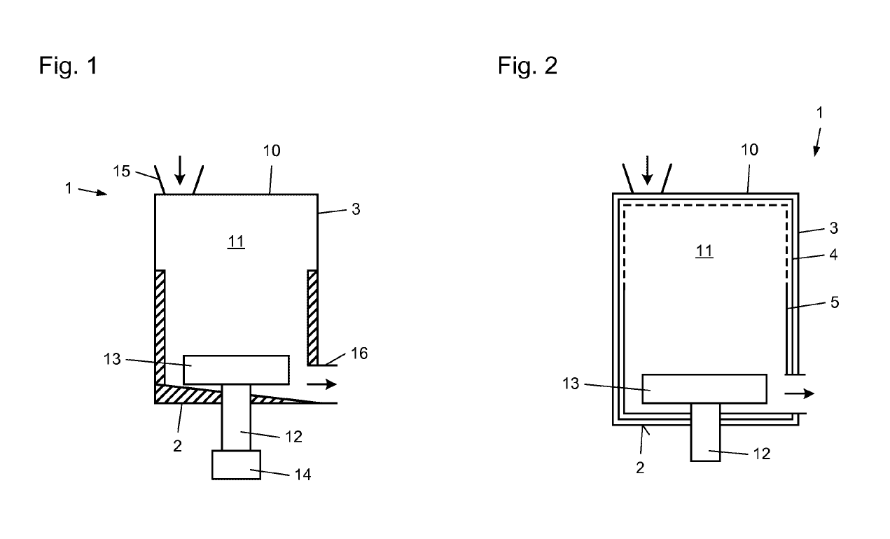

FIG. 1 schematically shows a section through a device with a vertically arranged driven shaft for rotating a striking means in an impact chamber defined by a housing,

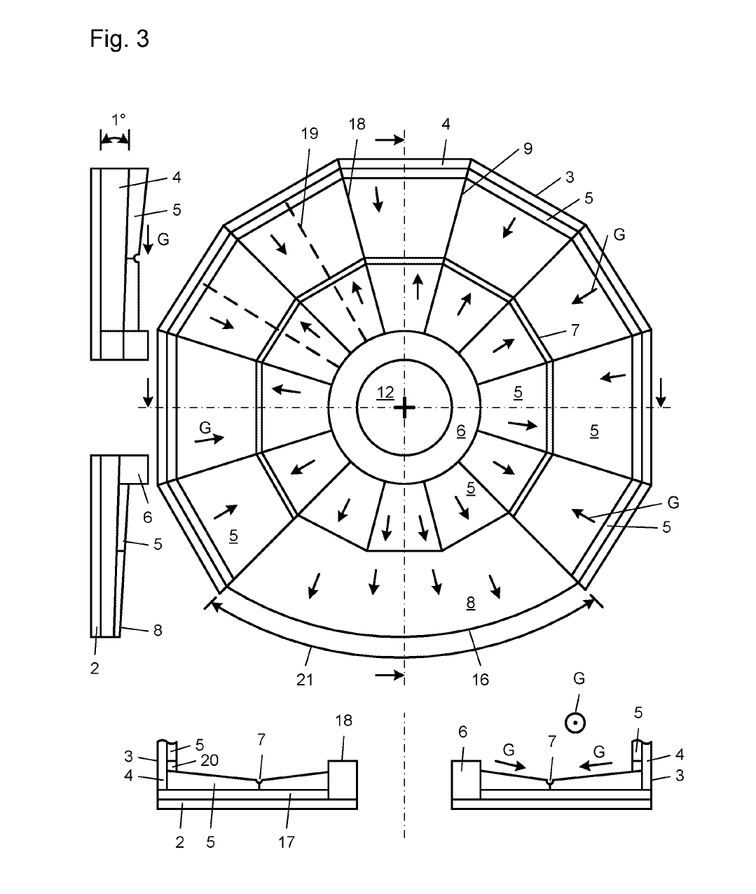

FIG. 2 shows a possible embodiment of the structure of the housing, the tub and the arrangement of the wear plates, and

FIG. 3 shows a plan view of the wear plates arranged on the bottom plate and two associated sections through the structure of the first layer of plastic and the wear plates arranged thereon.

FIG. 1 schematically shows a section through a device with a vertically arranged shaft 12 driven by a drive 14 for rotating a striking means 13 in an impact chamber 11 defined by a housing 1. The housing consists essentially of a base plate 2, a cover 10 and a wall 3 connecting them. It is preferably provided that an inlet opening 15 for the material flow is arranged in the cover 10 and an outlet opening 16 between bottom plate 2 and wall 3 for the comminuted material. The wall 3 can be formed in a cylindrical or polygonal manner. In the interior of the impact chamber 11, a layer of plastic for forming a tub 4 is arranged on the bottom plate 2 and adjacent to the bottom plate 2 at least on the lower parts of the wall 3. To illustrate a preferred gradient, the tub is drawn obliquely in the direction of the outlet opening 16 in the region of the bottom plate 2. In the outlet opening 16, an adjustable slide (not shown) is provided, which regulates the throughput or the amount of exiting material from the impact chamber 11.

In FIG. 2, the proposed structure of the layers attached within the housing 1 can be found on the example of the tub 4 enclosing the entire impact chamber 11. Here, it is formed from a layer of plastic, which is arranged on the cover 10, the bottom plate 2 and the wall 3. To protect the tub 4 and to minimize wear, a wear plate 5 is arranged on the tub 4 on the impact chamber side. The wear plate 5 is configured in the interior of the impact chamber 11 only according to the requirements, wherein the dashed line indicates the more optional range.

The production is preferably as follows. First, the impact chamber is lined from the inside with matching fittings (tub segments) made of plastic, which are welded together. The tub segments 17 are selected as required and according to the design of the tub (see FIG. 1) and comprise junction points 19. Particularly preferably, the tub segments 17 made of plastic already have the necessary gradient, as proposed in the various features according to the invention. At the junction points between the fittings, the material is preferably welded or glued. On the fittings made of plastic, the wear plates 5 are then also introduced as segments into the impact chamber 11 and arranged there at their corresponding position. Particularly preferably, the geometry of the segments of the wear plates will hold them in place. Particularly preferably, these can also be glued at certain points with the plastic or otherwise fixed.

FIG. 3 shows a plan view of the wear plates 5 arranged on the bottom plate 2 and two associated sections through the structure of the first layer of plastic and the wear plates 5 arranged thereon. The reference numeral for the wear plate 5 is not shown for each wear plate in order to maintain clarity of the illustration. In the region of the outlet opening 16, which has an opening angle 21, a preferably integral orifice plate 8 is arranged, via which the material and, above all, residual liquid can escape without difficulty. This orifice plate is preferably suitable to form a gradient G as a result of bearing on the tub or its geometry, which is shown with arrows and should correspond to the flow direction of a liquid. This embodiment further shows an outer ring of wear plates 5, which are arranged on the wall 3. In the section on the left side above, it can be seen that these wear plates 5 form a gradient G away from the wall 3 through the tub 4 and/or through their geometry 5. Next, there is an inner ring of wear plates 5. Between the outer and inner ring on wear plates 5, a channel 7 may be arranged, which is formed circumferentially all the way to the outlet opening 16 and/or the orifice plate 8 and especially guides residual liquid at a standstill or during cleaning out of the impact chamber 11 in the direction of outlet opening 16. As can be seen on the left in the section, the tub 4 preferably has a basic gradient of 1° for example in the direction of the outlet opening. As described, the inclination or the gradient of the wear plates 5 can vary for this purpose. Thus, the inner rim of the wear plates as shown has a gradient in the direction of the channel 7.

In the middle of the bottom plate 2, the shaft 12 is disposed, which is preferably guided in the region of the passage through an elevation in the tub. This elevation can be formed as a cone 6 and is shown more clearly in the lower sectional view. The cone 6 can be covered with wear plates 5 (not shown). Preferably, the surface 18 of the cone is plane-parallel to the plane of rotation of the impact tool to prevent clamping of materials between the cone and the impact tool.

By way of example, concealed junction points 19 between tub segments 17 of the tub 4 are shown at the top left with dashed lines. These are preferably located differently than the junction points 18 of the wear plates 5.

In the lower sectional view, the compensating pieces 20 are still shown, which can be arranged between the wear plates 5 of the wall 3 and the wear plates 5 of the bottom plate 2, to compensate for any angle or gradient specifications of the tub. Advantageously, it is then possible to use uniform and thus simpler wear plates 5 which are easier to produce.

### LIST OF REFERENCE NUMERALS

1 Housing
2 Bottom plate
3 Wall
4 Tub
5 Wear plate
6 Cone
7 Channel
8 Orifice plate
9 Junction point
10 Cover
11 Impact chamber
12 Shaft
13 Striking means
14 Drive
15 Inlet opening
16 Outlet opening
17 Tub segment
18 Surface
19 Junction point of 4
20 Compensating piece
21 Opening angle
G Gradient

1. A device for the comminution of moisture-containing materials, comprising:
a housing that forms an impact chamber having a rotating striker driven therein via a shaft,
wherein the housing comprises a bottom plate, a cover, a wall connecting the bottom plate and the cover, an inlet opening and an outlet opening,
wherein in the impact chamber, a tub comprising at least one layer of plastic is arranged at least along the bottom plate, and
wherein a wear plate is arranged on an other side of the layer of plastic.

2. The device according to claim 1, wherein the tub and/or the wear plate are designed in several parts and junction points are sealed in a materially bonded manner.

3. The device according to claim 1
wherein the tub comprises a multi-part tub and the wear plate comprises a multi-part wear plate, and
wherein the junction point of the tub segments of the multi-part tub and wear plate segments of the multi-part wear plate are arranged substantially spaced from each other.

4. The device according to claim 1, wherein in a region of the outlet opening on the bottom plate, the tub and/or the wear plate are integrally arranged as an orifice plate.

5. The device according to claim 1, wherein the wear plate is made of a material harder than a material of the housing.

6. The device according to claim 1, wherein in a region of the outlet opening, the wear plate and/or the tub are arranged with a gradient towards an outside of the housing.

7. The device according to claim 4, wherein the tub, the wear plate and/or the orifice plate are at least partially arranged in a region of the bottom plate with a gradient in a direction of the outlet opening.

8. The device according to claim 1, wherein the tub and/or the wear plate are arranged in a region of the bottom plate from the wall with a gradient in a direction of the shaft.

9. The device according to claim 1, wherein at least one depression in the wear plate and/or in the plastic is arranged on an impact chamber side in a region of the base plate to form a channel, wherein the channel is in operative connection with the outlet opening by a gradient.

10. The device according to claim 1, further comprising compensating pieces made of a same material as the wear plate are arranged between the wear plate of the wall and the wear plate of the bottom plate.

11. The device according to claim 1, wherein an elevation is arranged in a region of a passage of the shaft through the bottom plate, the tub and/or the wear plate in a direction of the impact chamber.

12. The device according to claim 11, wherein the surface of the elevation is arranged in a region of the striker plane-parallel to a plane of rotation of the striker.

13. The device according to claim 1, wherein the shaft is arranged inclined relative to the bottom plate and/or the shaft is arranged substantially perpendicularly to an orientation of a gradient in a direction of the outlet opening.

14. The device according to claim 3, wherein the junction points are arranged between the wear plate segments as a channel.

15. The device according to claim 3, wherein overlaps or tongue-and-groove connections are arranged at the junction points between the wear plate segments.

16. The device according to claim 1, wherein the shaft is vertically oriented within the housing.

17. The device according to claim 11, wherein the elevation is in a form of a cone.
